(19) United States
(12) Patent Application Publication
(10) Pub. No.: US 2014/0004861 A1
(43) Pub. Date: Jan. 2, 2014

(54) Dual Mode System for Wireless Communication

(71) Applicant: Yang-Seok Choi, Portland, OR (US)

(72) Inventor: Yang-Seok Choi, Portland, OR (US)

(21) Appl. No.: 13/992,824

(22) PCT Filed: Mar. 29, 2012
(86) PCT No.: PCT/US2012/031169

§ 371 Date: Jun. 10, 2013

(51) Int. Cl. H04W 36/04

(52) U.S. Cl. CPC H04W 36/04
USPC 455/437; 455/436

(57) ABSTRACT

A mobile device may establish a first wireless connection to a macro base station providing wide coverage in order to transmit control and/or broadcast channels, and may also establish a second wireless connection to a pico base station providing smaller coverage in order to transmit a high bandwidth data channel. These wireless connections may enable the mobile device to access a high speed channel within a picocell, while also maintaining continuous and reliable access to control and/or broadcast channels within a macrocell.

### BACKGROUND

This relates generally to wireless networks for mobile devices.

A mobile device can use wireless communication technology to establish a network connection. For example, the mobile device can establish a wireless connection to a base station in order to access a data network.

### BRIEF DESCRIPTION OF THE DRAWINGS

Some embodiments are described with respect to the following figures:

FIG. 1 is a depiction of an example network configuration in accordance with some embodiments;

FIG. 2 is a depiction of an example system in accordance with some embodiments;

FIG. 3 is a flow chart in accordance with some embodiments;

FIG. 4 is a schematic depiction of a mobile device and/or a base station in accordance with some embodiments.

### DETAILED DESCRIPTION

The popularity of wireless mobile devices (e.g., smart phones, tablets, handheld computers, etc.) has resulted in growing demand for wireless data access. One technique for increasing the available data bandwidth is to use higher frequencies for the wireless transmissions. However, as the transmission frequency increases, the size of the covered cell may decrease. Thus, when increasing the transmission frequencies, additional base stations may be required to provide continuous coverage of a given geographical area.

In accordance with some embodiments, a mobile device may establish a first wireless connection to a macro base station, providing wider coverage with smaller bandwidth and/or high power, in order to transmit control and/or broadcast channels. The mobile device may also establish a second wireless connection to a pico base station, providing smaller coverage with wider bandwidth and/or low power, in order to transmit a high bandwidth data channel. Such a dual mode approach may enable the mobile device to access a high speed channel within a smaller area, while also maintaining continuous access to control and/or broadcast channels within a larger area.

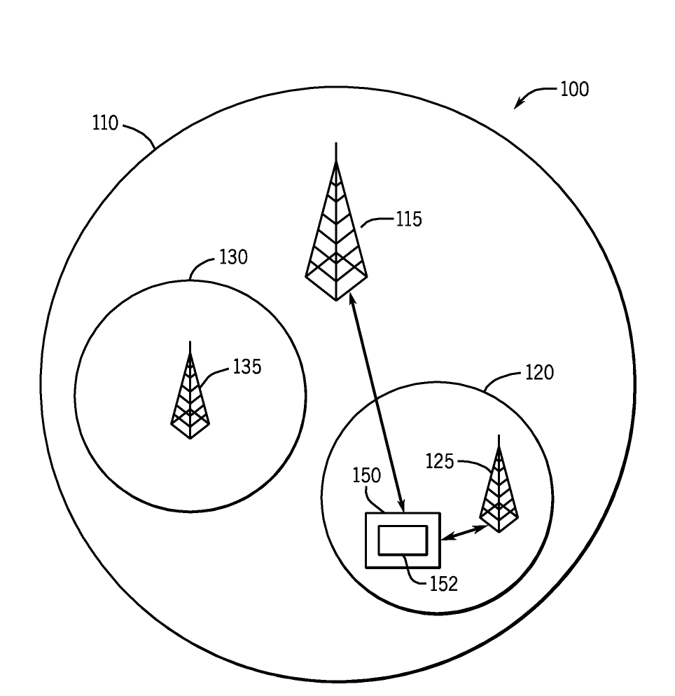

Referring to FIG. 1, an example network configuration 100 may include a mobile station 150, a macrocell 110, picocells 120 and 130, a macrocell base station 115, and picocell base stations 125 and 135. The macrocell 110 may be defined by the transmission range of the macrocell base station 115. As used herein, the term “macrocell” refers generally to a relatively larger wireless coverage area provided by a high power base station (e.g., a cellular telephone tower). For example, the macrocell 110 may have a diameter of 2 kilometers, 10 kilometers, 90 kilometers, etc.

The picocells 120 and 130 may be defined by the transmission ranges of picocell base stations 125 and 135, respectively. In accordance with some embodiments, the picocells 120 and 130 may be located within the macrocell 110. As used herein, the term “picocell” refers generally to a relatively smaller wireless coverage area provided by a low power base station (e.g., a public wireless hotspot, a home wireless router, a microcell node, a femtocell node, etc.). For example, the picocell 120 may have a diameter of 1 kilometer, 200 meters, 10 meters, etc.

In accordance with some embodiments, the size of the picocells 120, 130 may be limited by the operating frequency of the respective picocell base stations 125, 135. In other embodiments, the size of the picocells 120, 130 may be defined by the path loss, the transmitting power, and/or the antenna gain of the respective picocell base stations 125, 135.

In one or more embodiments, the mobile station 150 may be any mobile device configured to communicate via wireless communications technologies, such as a cellular telephone, a laptop computer or a handheld computer (e.g., a personal digital assistant) with a transceiver (i.e., a radio interface), etc. Further, the mobile station 150 may also be any vehicle (e.g., car, truck, boat, etc.) equipped with a radio interface.

In accordance with some embodiments, the mobile station 150 may include a dual mode module 152 to enable simultaneous wireless connections to a macrocell 110 and one or more picocells 120, 130. Such wireless connections may be based on any radio communications technologies and/or standards. For example, such wireless connections may include Long Term Evolution (LTE) connections (3rd Generation Partnership Project (3GPP) LTE standards, TS36 version 10.0, published October 2010), Wi-Fi connections (IEEE (Institute of Electrical and Electronics Engineers) 802.11 standard, IEEE 802.11-2007, published Jun. 12, 2007), Wi-MAX connections (IEEE 802.16 standard, IEEE 802.16-2004, published Oct. 1, 2004), etc.

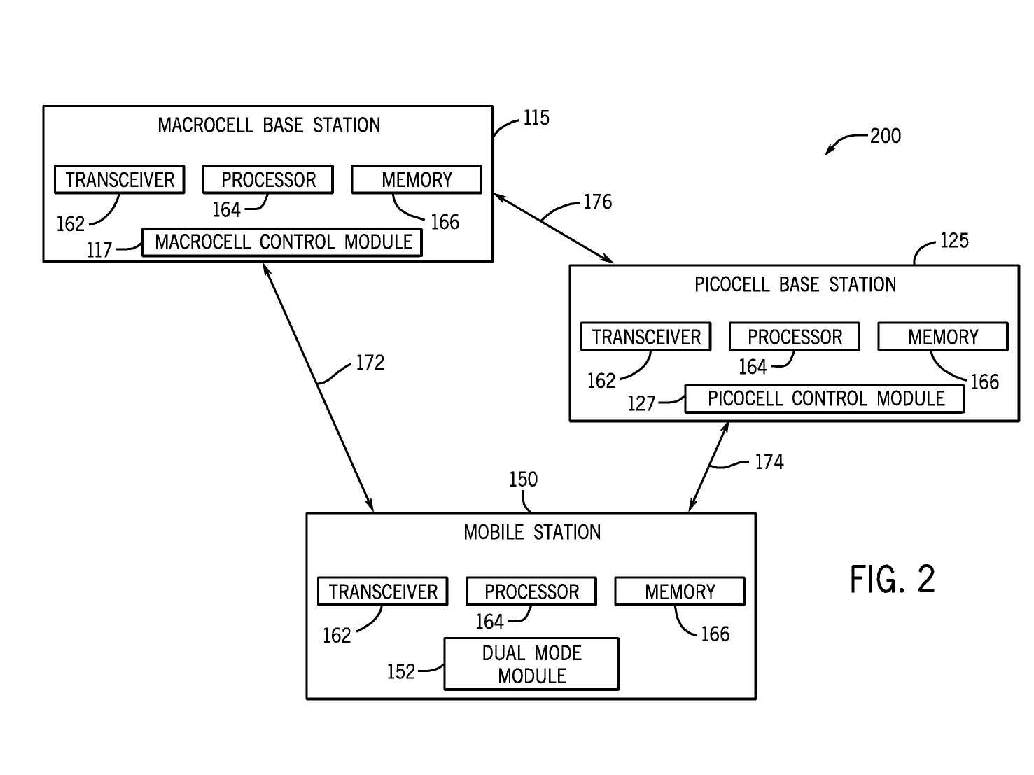

Referring to FIG. 2, an example system 200 may include the mobile station 150, the macrocell base station 115, and the picocell base station 125. As shown, the mobile station 150, the macrocell base station 115, and the picocell base station 125 may each include a transceiver 162, a processor 164, and a memory device 166. The mobile station 150 may also include the dual mode module 152. In addition, the macrocell base station 115 may also include a macrocell control module 117. Further, the picocell base station 125 may also include a picocell control module 127. Note that, while not shown in FIG. 2 for the sake of simplicity, the picocell base station 135 may include similar components to those included in the picocell base station 125.

In one or more embodiments, the dual mode module 152, the macrocell control module 117, and/or the picocell control module 127 may be implemented in hardware, software, and/or firmware. In firmware and software embodiments, they may be implemented by computer executed instructions stored in a non-transitory computer readable medium, such as an optical, semiconductor, or magnetic storage device.

In one or more embodiments, the dual mode module 152 and/or the macrocell control module 117 may include functionality to establish a macrocell connection 172 (i.e., a wireless connection between the mobile station 150 and the macrocell base station 115). The macrocell base station 115 may use the macrocell connection 172 to transmit control and/or broadcast channels to the mobile station 150. Optionally, the macrocell base station 115 may also use the macrocell connection 172 to transmit other channels (e.g., voice channels, low speed data channels, etc.).

In accordance with some embodiments, the dual mode module 152 and/or the picocell control module 127 may include functionality to establish a picocell connection 174 (i.e., a wireless connection between the mobile station 150 and the picocell base station 125). The picocell base station 125 may use the picocell connection 174 to transmit high speed data channels to the mobile station 150. Optionally, the picocell base station 125 may also use the picocell connection 174 to transmit other channels (e.g., voice channels, control channels, etc.). In one or more embodiments, the picocell connection 174 may have a higher bandwidth or data transfer rate than the macrocell connection 172.

In one or more embodiments, the dual mode module 152 may include functionality to establish and/or maintain the picocell connection 174 using broadcast and/or control channels transmitted by the macrocell connection 172. For example, establishing and/or maintaining the picocell connection 174 may be based on information transmitted by the macrocell connection 172, such as network identifiers, transmission schedules, channel frequencies, access requests/approvals, transmission contexts, etc.

In one or more embodiments, the macrocell control module 117 and/or the picocell control module 127 may include functionality to establish a network connection 176 between a macrocell base station and each picocell base station (e.g., between macrocell base station 115 and picocell base station 125, between macrocell base station 115 and picocell base station 135, etc.). The network connection 176 may be any type of network connection (e.g., a wired connection, a wireless connection, etc.).

In one or more embodiments, the network connection 176 may enable the macrocell base station 115 and the picocell base station 125 to coordinate dual mode transmissions to the mobile station 150. For example, referring to FIG. 1, assume that the physical movement of mobile station 150 causes it to exit picocell 120 and then enter picocell 130. In this situation, the macrocell base station 115 may use a network connection 176 to coordinate a handoff of a data channel from picocell base station 125 to picocell base station 135.

In accordance with some embodiments, the macrocell connection 172 and the picocell connection 174 may use carrier frequencies included within specific frequency bands. As used herein, the term “frequency band” may refer to a predefined range of radio frequency spectrum. For example, some frequency bands include 10-20 MHz, 200-400 MHz, 700-900 MHz, 1-2 GHz, 3.5-20 GHz, etc.

In one or more embodiments, the macrocell connection 172 may use a lower frequency band than the picocell connection 174. For example, the macrocell connection 172 may use a frequency band lower than 3.5 GHz, while the picocell connection 174 may use a frequency band higher than 3.5 GHz. In this example, the use of a higher frequency for the picocell connection 174 may enable the power spectral density or power per subcarrier to be smaller with a larger path loss. In other embodiments, the macrocell connection 172 and the picocell connection 174 may use different carrier frequencies included within the same frequency band.

In one or more embodiments, the dual mode functionality of the mobile station 150 may be selectively enabled based on a service level associated with the mobile station 150 and/or a user thereof. For example, the dual mode module 152, the macrocell control module 117, and/or the picocell control module 127 may include functionality to determine the service level associated with a current user of the mobile station 150 (or with the mobile station 150 itself), and to limit use of the picocell connection 174 based on the determined service level. Such a determination of service level may be based on, e.g., an account identifier, a subscription level, a credit rating, an affiliate program, a preferred status, contract terms, a Quality of Service agreement, etc. Further, the dual mode module 152, the macrocell control module 117, and/or the picocell control module 127 may include functionality to enable dual mode functionality only if the determined service level meets or exceeds a predefined level or threshold.

Note that the examples shown in FIGS. 1 and 2 are provided for the sake of illustration, and are not intended to limit embodiments of the invention. For example, embodiments of the invention may include any number and/or arrangement of macrocells and picocells. Further, it is contemplated that the wireless connections may include other nodes not shown in FIGS. 1 and 2 (e.g., relay nodes, repeaters, etc.). In another example, it is contemplated that the macrocell connection 172 and/or the picocell connection 174 may be used to transmit any combination of broadcast, control, data, or other channels. In still another example, it is contemplated that the mobile station 150, the macrocell base station 115, and/or the picocell base station 125 may include any number of transceivers 162, processors 164, and/or memory devices 166. For instance, in some embodiments, the mobile station 150 may use a first transceiver 162 to communicate with the macrocell base station 115, and may use a second transceiver 162 to communicate with the picocell base station 125.

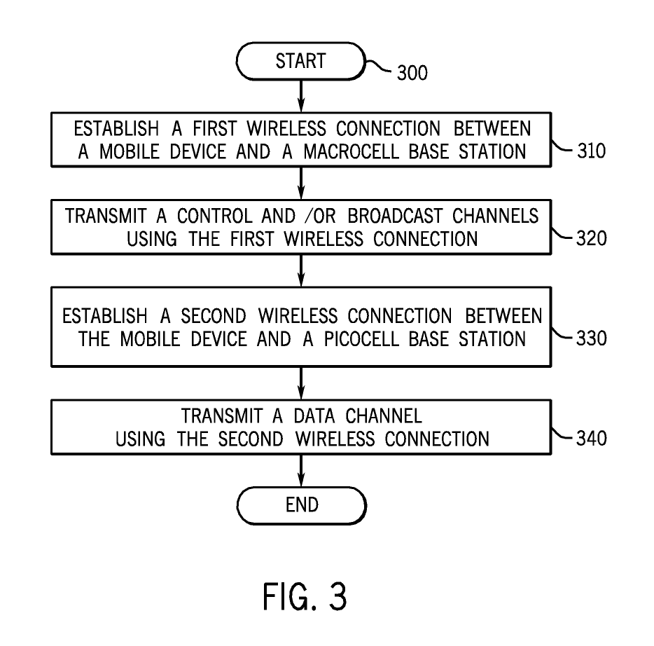

FIG. 3 shows a sequence 300 for dual mode connections in accordance with one or more embodiments. The sequence 300 may be implemented in hardware, software, and/or firmware. In firmware and software embodiments it may be implemented by computer executed instructions stored in a non-transitory computer readable medium, such as an optical, semiconductor, or magnetic storage device. In one embodiment, the sequence 300 may be part of the dual mode module 152, the macrocell module 117, and/or the picocell control module 127 shown in FIG. 1. In another embodiment, the sequence 300 may be implemented by any other component(s) of the mobile station 150, the macrocell base station 115, and/or the picocell base station 125.

At step 310, a first wireless connection between a mobile device and a macrocell base station may be established. For example, referring to FIG. 2, a macrocell connection 172 may be established between the mobile station 150 and the macrocell base station 115.

At step 320, a control channel and/or a broadcast channel may be transmitted using the first wireless connection. For example, referring to FIG. 2, the macrocell base station 115 may use macrocell connection 172 to transmit a control channel transmission to the mobile station 150. Optionally, in one or more embodiments, the first wireless connection may also be used to transmit other channels (e.g., data channels, voice channels, etc.).

At step 330, a second wireless connection may be established between the mobile device and a picocell base station. In one or more embodiments, establishing the second wireless connection may involve using the control channel transmitted by the first wireless connection. For example, referring to FIG. 2, the picocell connection 174 may be established using network information (e.g., identifiers, schedules, frequencies, credentials, contexts, permissions, etc.) obtained from one or more control channels transmitted by the macrocell connection 172.

At step 340, a data channel may be transmitted using the second wireless connection. For example, referring to FIG. 2, the picocell base station 125 may use the picocell connection 174 to transmit a data channel transmission to the mobile station 150. In one or more embodiments, the data channel transmitted by the picocell connection 174 may be a high speed data channel. In this manner, the mobile station 150 may obtain high speed data access within the picocell 120, while also maintaining broadcast channel and control channel access throughout the macrocell 110. After step 340, the sequence 300 ends.

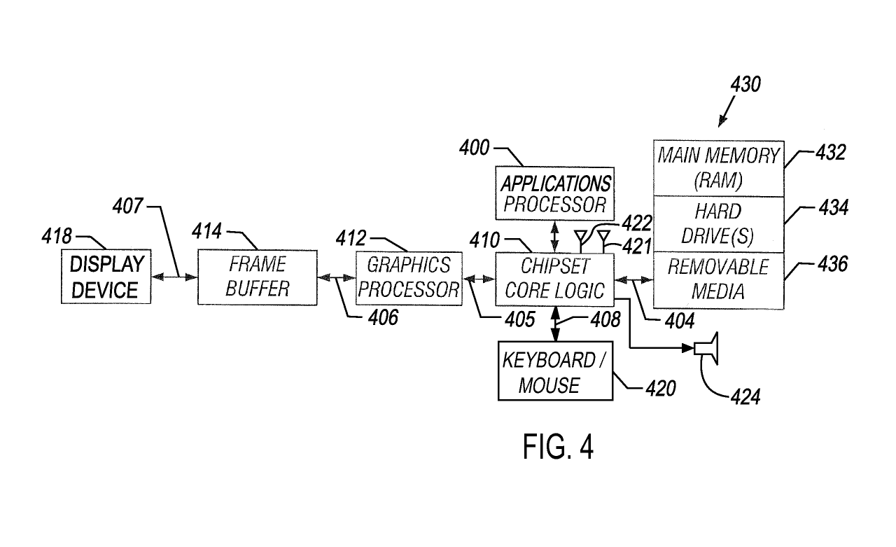

FIG. 4 depicts a computer system 430, which may be the mobile station 150, the macrocell base station 115, and/or the picocell base station 125 shown in FIGS. 1-2. The computer system 430 may include a hard drive 434 and a removable storage medium 436, coupled by a bus 404 to a chipset core logic 410. A keyboard and mouse 420, or other conventional components, may be coupled to the chipset core logic via bus 408. The core logic may couple to the graphics processor 412 via a bus 405, and the applications processor 400 in one embodiment. The graphics processor 412 may also be coupled by a bus 406 to a frame buffer 414. The frame buffer 414 may be coupled by a bus 407 to a display screen 418, such as a liquid crystal display (LCD) touch screen. In one embodiment, the graphics processor 412 may be a multi-threaded, multi-core parallel processor using single instruction multiple data (SIMD) architecture.

The chipset logic 410 may include a non-volatile memory port to couple the main memory 432. Also coupled to the core logic 410 may be a radio transceiver and antenna(s) 421, 422. Speakers 424 may also be coupled through core logic 410.

The following clauses and/or examples pertain to further embodiments:

One example embodiment may be a method for wireless communication, including: receiving a control channel transmission from a macrocell base station via a first wireless connection; and receiving a data channel transmission from a first picocell base station via a second wireless connection, wherein the control channel transmission is to control the second wireless connection, wherein the first wireless connection uses a lower frequency band than the second wireless connection. The method may also include controlling the second wireless connection based on the control channel transmission. The method may also include transferring, using the control channel transmission, the second wireless connection from the first picocell base station to a second picocell base station. The method may also include receiving a broadcast channel transmission from the macrocell base station via the first wireless connection. The method may also include receiving a second control channel transmission from the first picocell base station via the second wireless connection. The method may also include receiving the data channel transmission at a higher data rate than the control channel transmission. The method may also include determining a service level for the second wireless connection. The method may also include receiving the control channel transmission using a first antenna. The method may also include receiving the data channel transmission using a second antenna.

One example embodiment may be an apparatus arranged to perform the above-described method.

Another example embodiment may be a machine readable medium comprising a plurality of instructions that in response to being executed by a computing device, cause the computing device to carry out the above-described method.

One example embodiment may be a mobile device including: at least one antenna; and a dual mode module coupled to the antenna, the dual mode module to: receive a control channel transmission from a macrocell base station via a first wireless connection; and receive a data channel transmission from a picocell base station via a second wireless connection, wherein the control channel transmission is to control the second wireless connection, wherein the second wireless connection uses a higher frequency band than the first wireless connection. The mobile device may also include a display device. In the mobile device, the dual mode module may also receive the data channel transmission at a higher data rate than the control channel transmission. In the mobile device, the dual mode module may also determine a service level for the second wireless connection. The mobile device may be a smartphone.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. For example, it is contemplated that the above described processes may be performed at any location(s) in the network (e.g., at a mobile station, at the macrocell or picocell base station level, at a network level, or any combination thereof). Further, specifics in the examples may be used anywhere in one or more embodiments. It is intended that the appended claims cover all such modifications and variations as fall within the true spirit and scope of this present invention.

1-16. (canceled)

17. A method comprising:
establishing a first wireless connection between a mobile device and a macrocell base station;
transmitting a control channel using the first wireless connection;
establishing, using the control channel, a second wireless connection between the mobile device and a picocell base station; and
transmitting a first data channel using the second wireless connection.

18. The method of claim 17 including controlling the first data channel using the control channel.

19. The method of claim 17 including:
establishing a third wireless connection between the mobile device and a second picocell base station; and
transferring, using the control channel, the first data channel from the second wireless connection to the third wireless connection.

20. The method of claim 17 including transmitting a broadcast channel using the first wireless connection.

21. The method of claim 17 including transmitting a second control channel using the second wireless connection.

22. The method of claim 17 including establishing the first wireless connection using a first frequency band and establishing the second wireless connection using a second frequency band, wherein the first frequency band is lower than the second frequency band.

23. The method of claim 17 including establishing the first wireless connection using a first carrier frequency and establishing the second wireless connection using a second carrier frequency, wherein the first carrier frequency and the second carrier frequency are included in a same frequency band.

24. The method of claim 17 including transmitting a second data channel using the first wireless connection, the first data channel having a faster data transfer rate than the second data channel.

25. A mobile device comprising:
a hardware processor; and
a dual mode module executed by the hardware processor, the dual mode module to:
establish a first wireless connection to a macrocell base station;
receive a control channel using the first wireless connection;
establish, based on the control channel, a second wireless connection to a picocell base station; and
receive a first data channel using the second wireless connection.

26. The mobile device of claim 25, wherein the dual mode module is also to control the first data channel based on the control channel.

27. The mobile device of claim 25, wherein the dual mode module is also to:
establish a third wireless connection between the mobile device and a second picocell base station; and
transfer, based on the control channel, the first data channel from the second wireless connection to the third wireless connection.

28. The mobile device of claim 25, wherein the dual mode module is also to receive a broadcast channel using the first wireless connection.

29. The mobile device of claim 25, wherein the dual mode module is also to determine a service level for the second wireless connection.

30. The mobile device of claim 25, wherein the dual mode module is also to:
establish the first wireless connection using a first frequency band; and
establish the second wireless connection using a second frequency band,
wherein the first frequency band is lower than the second frequency band.

31. The mobile device of claim 25, wherein the dual mode module is also to:
establish the first wireless connection using a first carrier frequency; and
establish the second wireless connection using a second carrier frequency,
wherein the first carrier frequency and the second carrier frequency are included in a same frequency band.

32. The mobile device of claim 25, wherein the dual mode module is also to receive a second data channel using the first wireless connection, the second data channel to have a slower data transfer rate than the first data channel.

33. A non-transitory computer readable medium storing instructions to cause a hardware processor to:
establish a macrocell connection between a mobile device and a macrocell base station;
transmit a control channel using the macrocell connection;
establish, using the control channel, a picocell connection between the mobile device and a picocell base station; and
transmit a first data channel using the picocell connection.

34. The medium of claim 33 further storing instructions to cause the hardware processor to control the first data channel using the control channel.

35. The medium of claim 33 further storing instructions to cause the hardware processor to establish a network connection between the picocell base station and the macrocell base station.

36. The medium of claim 35 further storing instructions to cause the hardware processor to use the network connection to coordinate the picocell connection and the macrocell connection.
